(19) United States
(12) Patent Application Publication
(10) Pub. No.: US 2009/0302983 A1
(43) Pub. Date: Dec. 10, 2009

(54) MAGNETIC FIELD SIMULATOR AND RELATED METHODS FOR SIMULATING THE EARTH'S MAGNETIC FIELD

(76) Inventors: Henry E. Payne, III, Charleston, WV (US); Daniel F. Hollenbach, Oak Ridge, TN (US)

Correspondence Address: WOOD, HERRON & EVANS, LLP, 2700 CAREW TOWER, 441 VINE STREET, CINCINNATI, OH, 45202, US

(21) Appl. No.: 12/135,771

(22) Filed: Jun. 9, 2008

(51) Int. Cl. H01F 3/00

(52) U.S. Cl. 335/297

(57) ABSTRACT

Apparatus and methods for simulating the Earth's magnetic field. The apparatus includes a spherical structure having a rotational axis and a molten metal therewithin. A support is coupled to the spherical structure so that the spherical structure is rotatable about a rotational axis. Rotation of the spherical structure generates inertial forces in the molten metal. The apparatus may include one or more magnetometers operatively coupled to an outer surface of the spherical structure for measuring a magnetic field generated by the spherical structure.

### TECHNICAL FIELD

The present invention generally relates to apparatus and methods for generating a magnetic field, and more specifically, to apparatus and methods for simulating the magnetic field of the Earth.

### BACKGROUND

Earth is known to have a magnetic field, which, among other things, protects the planet's atmosphere from the effects of solar radiation. The source of Earth's magnetic field, however, is not well known. Various theories having been advanced to attempt to define and explain the source.

Several unknowns remain regarding the magnetic field of planet Earth. For example, the pressure in the inner core of the earth is estimated to be about three (3) million bars. The effect of this extremely high pressure on the melting point of the materials making up the inner core or the melting point of the materials making up an outer core, which surrounds the inner core, is also unknown. Similarly, the source of heat energy that creates and maintains the temperatures of the inner and outer cores of the Earth is also unknown, especially in light of the many heat-leaking “weep holes” that are known to exist throughout the planet connecting the mantel to the crust of the planet and the approximate 4.5 billion year lifetime of the Earth.

Likewise, the reasons for the observed reversal of the magnetic field of the Earth are also unknown. This reversal has been estimated to occur about every 200,000 years. Finally, the effect of high-energy particles on iron-based magnetic fields is similarly unknown.

It would be desirable, therefore, to provide apparatus and methods that address one or more of the above unknowns, as well as other deficiencies in the understanding of the origin of the Earth's magnetic field.

### SUMMARY

In one embodiment, an apparatus is provided for generating a magnetic field. The apparatus includes a spherical structure having a rotational axis and including a molten metal therewithin. The molten metal may, for example, include molten iron. A support is coupled to the spherical structure at least at one point associated with the rotational axis. The spherical structure is rotatable relative to the support and about the rotational axis, with rotation of the spherical structure and a seed current or magnetic field generating the magnetic field. The apparatus may include a magnetometer operatively coupled to an outer surface of the spherical structure for measuring the magnetic field. A first drive mechanism may be operatively coupled to the spherical structure to effect rotation thereof about the rotational axis. The first drive mechanism may additionally or alternatively be configured to rotate the spherical structure at a speed of about one rotation about every ten seconds.

The apparatus may include a main drive mechanism operatively coupled to the support and configured to revolve the spherical structure in an orbit about an orbital motion axis that is spaced from the spherical structure. The main drive mechanism may be configured to revolve the spherical structure to define a generally circular or elliptical path, which may have a radius of about five meters in certain specific embodiments. The main drive mechanism may be additionally or alternatively configured to revolve the spherical structure about the orbital motion axis at a speed of about one revolution per minute.

The support may be coupled to two diametrically opposed points on the spherical structure, with the support including at least one thrust bearing at one of the two diametrically opposed points for supporting the spherical structure. The apparatus may include a device positioned to selectively inject energetic charged particles or an electric current into the molten metal of the outer core or into the solid inner core. The spherical structure may include an inner core and an outer core disposed about the inner core, with the inner core including at least one material selected from the group consisting of nickel, chrome, and iron steel. The outer core may contain the molten metal therein. The outer core may have a shape defined by a nickel superalloy chamber and the molten metal is contained within the chamber.

The spherical structure may include a conduit fluidly communicating the chamber with an outer surface of the spherical structure. The conduit may define a longitudinal axis tilted or oriented at an angle relative to the rotational axis. The angle between the longitudinal axis and rotational axis may, for example, be about 11°. The spherical structure may include a plurality of heaters operatively coupled to the chamber for heating the molten metal contained in the chamber.

The spherical structure may be scaled to be about 1/10,000,000 the size of planet Earth. The spherical structure may include an outer-most layer composed of a polycarbonate material. The spherical structure may include a chamber containing the molten metal and a solid structure disposed about the chamber, with the solid structure including at least one material, such as limestone or granite, that acts as a thermal insulator so that the outer-most layer remains relatively cool. Alternatively, the solid structure may be composed of magma basalt silicates.

In another embodiment, an apparatus is provided for generating a magnetic field and includes a spherical structure having a rotational axis and having a molten metal therewithin. A support is coupled to the spherical structure at least at one point associated with the rotational axis, with the spherical structure being rotatable relative to the support and about the rotational axis. A main drive mechanism is operatively coupled to the support and is configured to rotate the spherical structure about an orbital motion axis that is spaced from the spherical structure. Rotation of the spherical structure about the rotational axis and about the orbital motion axis generates the magnetic field.

In yet another embodiment, a method is provided for generating a magnetic field. The method includes pouring a molten metal such as one including molten iron, for example, into a spherical structure and rotating the spherical structure about a rotational axis thereof to thereby induce Coriolis inertia forces in the molten metal. The method may include rotating the spherical structure about an orbital motion axis that is spaced from the spherical structure. Rotating the spherical structure about the orbital motion axis may define a generally circular or elliptical path. Rotating the spherical structure about the orbital motion axis may, for example, be at a speed of about one revolution per minute. The method may include rotating the spherical structure about the rotational axis at a speed of about one rotation every ten seconds. The method may include injecting energetic charged particles or an electric current into the molten metal of the outer core or the solid inner core.

### BRIEF DESCRIPTION OF THE DRAWINGS

FIG. 1 is a perspective view of an apparatus for generating a magnetic field in accordance with the an embodiment of the invention;

FIG. 2 is a partial perspective view of a globe of the apparatus of FIG. 1, in which an interior portion is visible;

FIG. 3 is a front view of the interior portion of FIG. 2;

FIG. 4 is a perspective view of the support and globe of the apparatus of FIG. 1;

FIG. 5 is a perspective view similar to FIG. 1 showing a different embodiment of an apparatus for generating a magnetic field in accordance with an alternative embodiment of the invention;

FIG. 5A is a cross-sectional view taken generally along line 5A-5A in FIG. 5; and

FIG. 6 is a perspective view of the globe of the apparatus in a partially assembled state with the support omitted for clarity of illustration.

### DETAILED DESCRIPTION

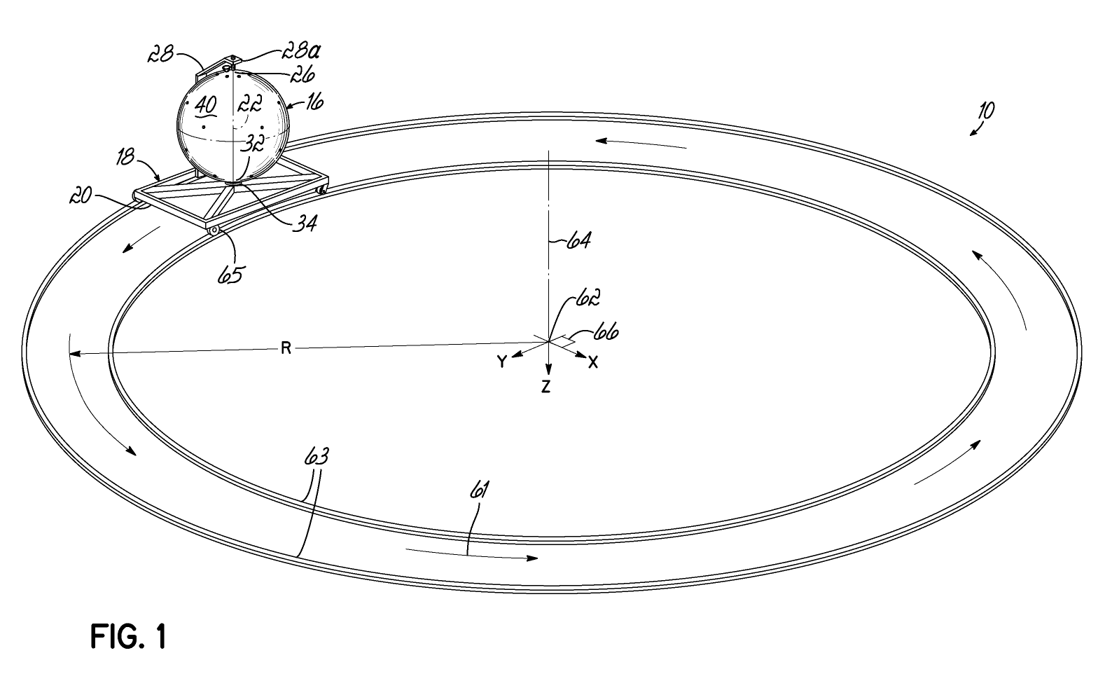

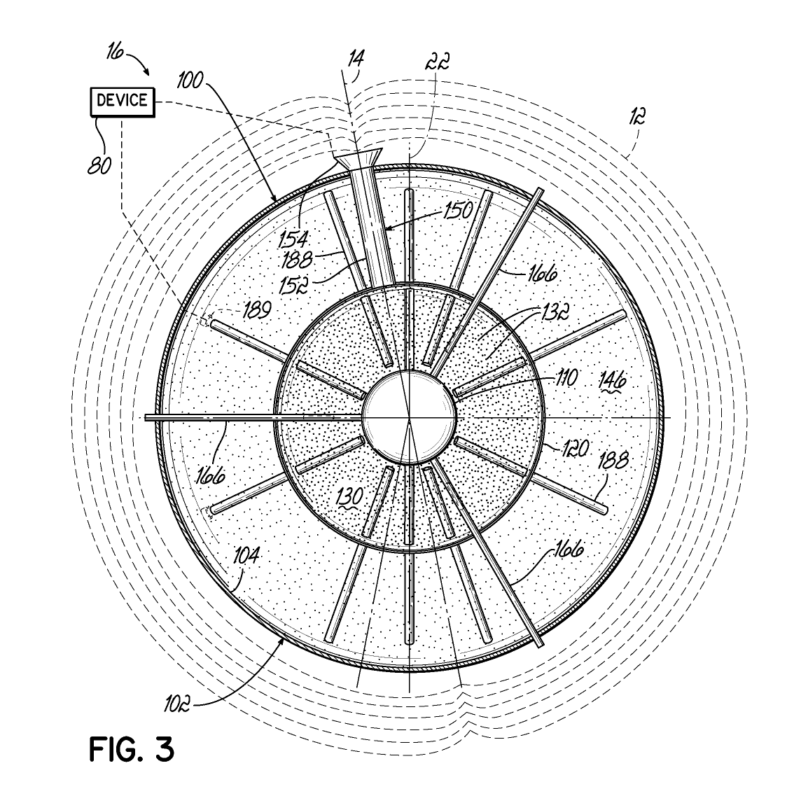

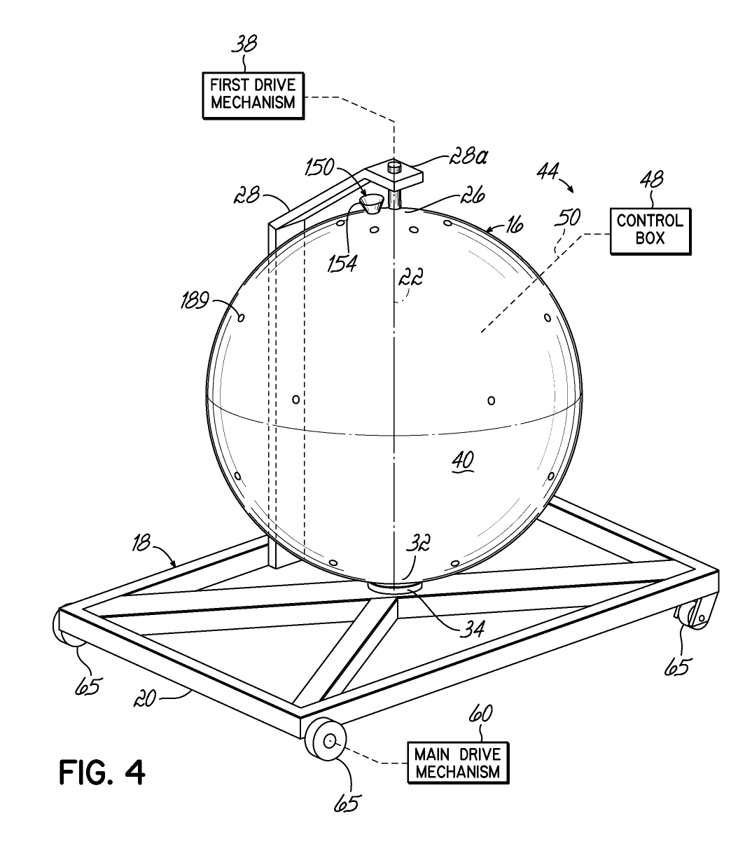

With reference to the figures and more particularly to FIGS. 1-4, an exemplary apparatus 10 is illustrated for generating a magnetic field 12 (FIG. 3), schematically represented by dashed lines and oriented to define a North-South magnetic axis 14. The magnitude of the magnetic field 12 may be as small as approximately 500 milligauss. Apparatus 10 includes a spherical structure in the form of a globe 16 that is sized, in this embodiment, to be about 1/10,000,000 of the size of planet Earth. Globe 16 is supported by a support 18 in the form of a carriage or cart having a cross-frame 20 with pivot arms that support the weight of the globe 16. The support 18 is coupled to the globe 16 at least at one point along a rotational axis 22 of the globe 16. In this exemplary embodiment, for example, the support 18 is coupled to the globe 16 at two diametrically opposed points of the globe 16. In particular, support 18 is coupled to the globe 16 at a top point 26 coincident with an end 28a of a bracket 28 of the support 18, as well as at a bottom point 32 of the globe 16. The top and bottom points 26, 32 may represent the geographical poles of the globe 16. Notably, a thrust bearing 34 is disposed adjacent bottom point 32, and is supported by the cross-frame 20 to thereby support the weight of the globe 16.

A schematically depicted first drive mechanism 38 is operatively coupled to the globe 16 for rotating globe 16 about its rotational axis 22, for example, at a speed of about one rotation every ten seconds. This simulates planetary rotation. For example, and without limitation, the first drive mechanism 38 could take the form of a motor and gearset mounted on the bracket 28 of support 18 and coupled to an outer surface 40 of the globe 16. More specifically, for example, a selected motor could be one having an output less than about ½ HP and be rated for 90 volts DC, such as a motor having model number 3XA2 and commercially available from Grainger, Inc. of Lake Forest, Ill. First drive mechanism 38 may include a feature permitting adjustment of the speed of rotation of globe 16 about rotational axis 22. For example, and without limitation, such feature may include a plurality of gears, each of which capable of being selectively coupled to a motor to adjust the resulting speed of rotation of globe 16 about rotational axis 22.

As explained in further detail below, rotation of the globe 16 about the rotational axis 22 induces inertial forces in the material confined within the globe 16, which is believed to be capable of generating the magnetic field 12 although Applicants do not wish to be bound by theory. In this regard, the magnetic field 12 can be measured by one or more magnetometers 44 operatively coupled to the outer surface 40 of globe 16. For example, and without limitation, the magnetic field 12 can be measured using an AlphaLab Earth Magnetometer, commercially available from AlphaLab, Inc. of Salt Lake City, Utah. More specifically, the exemplary magnetometer 44 includes a control box 48 and one or more probes 50 connected thereto and which contacts the space adjacent the globe 16. In this regard, the term “operatively coupled to the outer surface” is intended to cover magnetometers that make physical contact with the outer surface 40 of globe 16 as well as those that simply contact the space adjacent outer surface 40 without necessarily physically contacting the outer surface 40.

With continued reference to FIGS. 1-4, a main drive mechanism 60 is operatively coupled to the support 18 for rotating the globe 16 in an orbit about a center 62. In this regard, center 62 is located along an orbital motion axis 64 of the apparatus 10 and which is spaced from the globe 16. Main drive mechanism 60 may, for example, include a motor and a transmission in the representative form of a transmission or gearset (not shown) operatively coupled to the support 18 and which in turn rotates the support 18 and the globe 16 about center 62. Main drive mechanism 60 may be configured to rotate globe 16 at a speed of about one revolution per minute and may be additionally further configured to rotate the globe 16 about a generally circular or elliptical path 61, which may have a radius “R” of about five (5) meters in a specific embodiment. Moreover, main drive mechanism 60 may have a feature that allows adjustment of the speed of rotation of globe 16 about center 62. The examples provided above for the first drive mechanism 38 are similarly applicable to main drive mechanism 60. Main drive mechanism 60 may for example be coupled to one or more of wheels 65, such as rubber tires, of the support 18. In this exemplary embodiment, a track 63 formed from, for example, a single-piece or multiple-piece aluminum extrusion guides the direction of movement of wheels 65 to further define rotation of globe 16 about center 62 and orbital motion axis 64, thereby defining a plane 66 of orbital motion of globe 16.

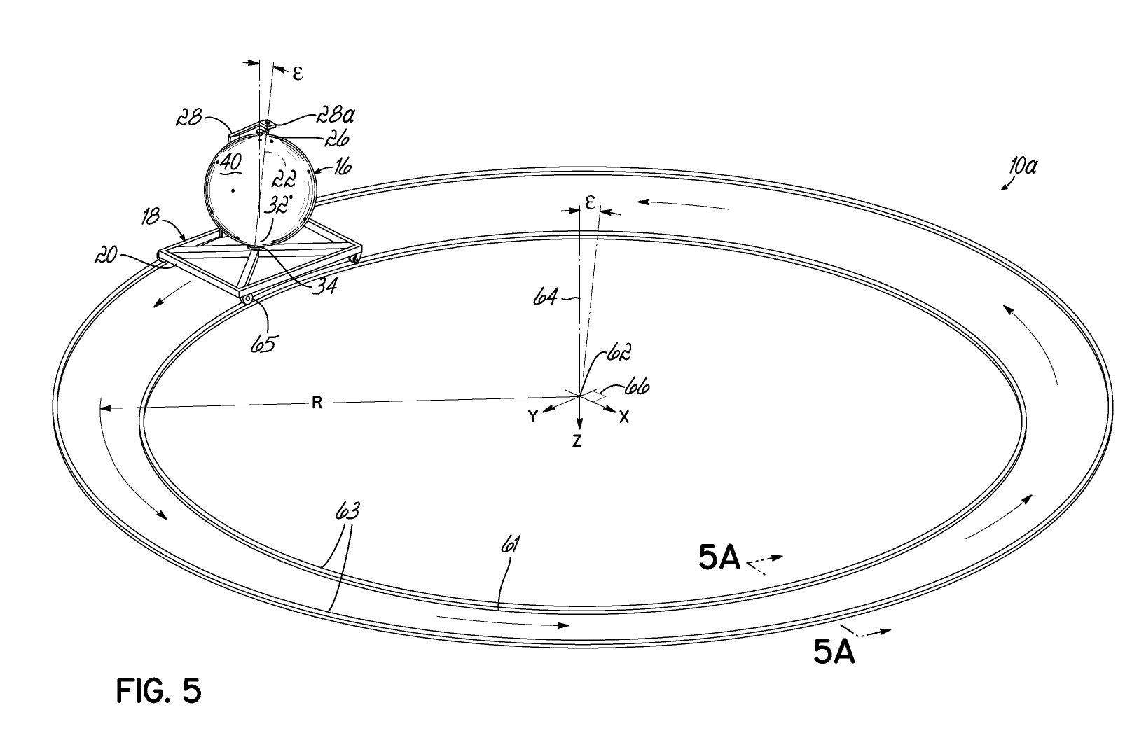

While the exemplary embodiment of FIGS. 1-4 includes the rotational axis 22 as being generally perpendicular to orbital plane 66 of globe 16, those of ordinary skill in the art will readily appreciate that this is merely exemplary and, therefore, not intended to be limiting. For example, the track 63 may be modified, as shown in FIG. 5, by banking or inclination such that the rotation axis 22 defines a tilt angle, ε, relative to an imaginary line 67 that is perpendicular to the plane 66. This tilt angle, ε, may, for example, be in the range of about 23 to about 24 degrees, thereby permitting simulation of the observed axial tilt or “obliquity of the ecliptic” defined by the rotational and orbital motion of the Earth. Alternatively, the coupling of the globe 16 to the support 18 may be modified so that the support 18 is tilted by the tilt angle, ε, and the track 63 is level.

Rotation of the globe 16 about the rotational axis 22 and about the center 62 respectively simulates the observed rotational and orbital motion of the Earth respectively about its own axis and about the sun. As discussed in further detail below, rotation of the globe 16 about rotational axis 22 and orbital motion axis 64 is believed to generate magnetic field 12 that extends about the globe 16. Moreover, a charged particle delivery device 80, such as an electron gun, of the apparatus 10 may be positioned to selectively inject energetic charged particles into an interior of the globe 16 to cooperate in the generation of the magnetic field 12.

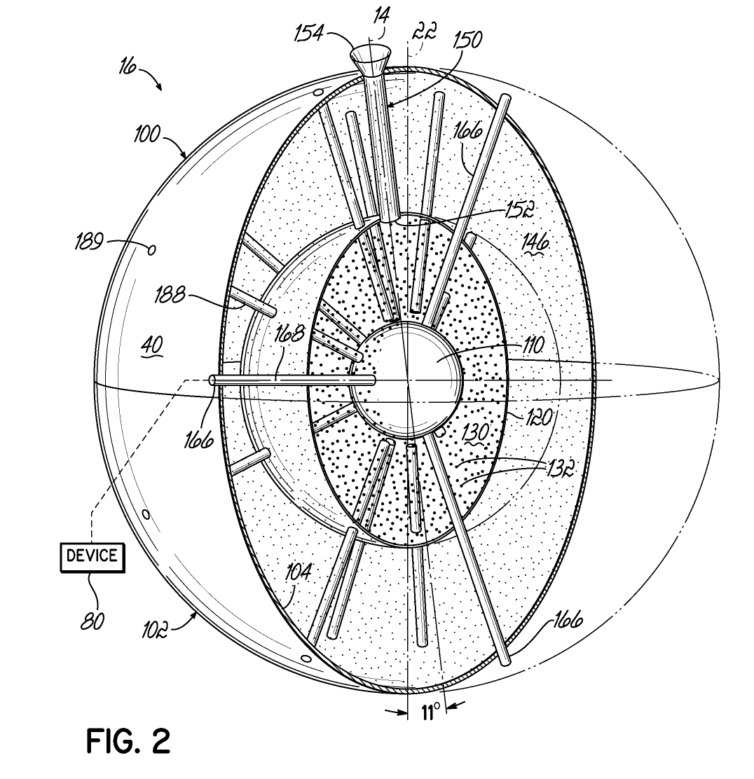

With particular reference to FIGS. 2 and 3, the structure and materials defining globe 16 cooperate with motion thereof, as described above, to generate magnetic field 12, although the Applicants do not wish to be bound by theory. To this end, the overall exterior shape of globe 16 is defined by two complementary hemispherical shells 100 and 102 (shell 102 shown in phantom) that are coupled to one another, for example via fasteners such as bolts, to thereby define the spherical shape of globe 16. In this regard, the hemispherical shells 100, 102 of this exemplary embodiment define an outer layer or crust 104 of globe 16. The hemispherical shells 100, 102, which define the largest sphere of the globe 16 when joined together, are composed of a cured polycarbonate resin thermoplastic with a thickness of, for example, about 25 mm. In one embodiment, the cured polycarbonate resin thermoplastic may be LEXAN®. An inner core 110, which represents the smallest sphere of globe 16, is disposed at the center of the globe 16 and is made of a solid material. In this embodiment, inner core 110 includes cast steel containing nickel, chrome, and iron. Those of ordinary skill in the art will readily appreciate that inner core 110 may be alternatively made of other materials. For example, inner core 110 may be made of a material including any or all of the materials discussed above or other materials, so long as the selection of materials permits the inner core 110 to remain in a solid state.

An outer core 120 is disposed within globe 16 and about inner core 110. Outer core 120 includes a pair of opposed hemispherical shells 122 (only one shown) united to form the outer core 120. The shells 122 may be composed of an austenitic nickel-based superalloy, such as Inconel®, although the outer core 120 may alternatively be composed of other types of materials. Outer core 120, which defines a sphere characterized by a radius intermediate of the radius of the inner core 110 and the crust 104, defines an internal chamber 130 that confines or contains a molten metal 132 (depicted in the drawings as a pattern of dots for illustrative purposes).

In one embodiment, the molten metal 132 is composed of gray iron heated to a temperature adequate to liquefy the solid material and place it into a molten state. It is contemplated, however, that molten metal 132 may include other materials in addition to or as an alternative to the molten iron of this exemplary embodiment. Gray iron or grey iron, which was the original “cast iron”, is an alloy of carbon, silicon, and iron, containing from 1.7 to 4.5% C and 1 to 3% Si. Moreover, the exemplary molten metal 132 of this embodiment has eutectic phase change and melting points in the range of about 1160° C. to about 1200° C.

Gray iron is characterized by a Curie point of about 770° C. The Curie point of a ferromagnetic material like gray iron is the temperature above which it loses its characteristic ferromagnetic ability. At temperatures below the Curie point, the magnetic moments are partially aligned within magnetic domains in ferromagnetic materials. As the temperature is increased towards the Curie point, the alignment (magnetization) within each domain decreases. Above the Curie point, the material is purely paramagnetic and there are no magnetized domains of aligned moments. Some metals, such as sodium, are paramagnetic, and lack a Curie point or magnetic polarity in any form. When molten, gray iron is purely paramagnetic as the Curie point is far exceeded. Gray iron has a high 18,000 gauss saturation (B) or residual flux density, and a high 6,500-9,000 gauss retentivity (H) magnetizing capacity.

In the representative embodiment, gray iron is relatively non-reactive metal, in comparison to more reactive metals like sodium. Gray iron has a relatively high specific gravity of about 7.5, in comparison with less dense metals like sodium that is characterized by a specific gravity of only about 0.93. The comparatively high specific gravity (density) of gray iron is attractive because it is believed to promote the simulation of the inertial forces. The comparatively high melting point of gray iron is believed to be attractive for promoting convective heat transfer, which may be difficult to promote with metals characterized by a lower melting point, such as sodium. The existence of a eutectic phase change also enhances the attractiveness of gray iron over other alternative metals that lack a eutectic phase change, such as sodium.

Notably, one or both of the rotational motion of globe 16 about rotational axis 22 and orbital motion axis 64 causes movement of the molten metal 132 within outer core 120. More specifically, movement of the molten metal 132 generates Coriolis inertial forces in the molten metal 132. Although not wishing to be bound by theory, the Coriolis inertial forces in the molten metal 132 are believed to cooperate with naturally occurring convection currents within the chamber 130 to form electric currents in rolls aligned along the magnetic axis 14, thereby generating the magnetic field 12, although Applicants do not wish to be bound by theory. Convection currents may occur as a result of the temperature gradients existing across chamber 130 and within the molten metal 132. When a conducting fluid, such as molten metal 132, flows across the magnetic field 12, additional electric currents are induced, which, in turn, continue to generate magnetic field 12 in a self-perpetuating mechanism, although Applicants do not wish to be bound by theory.

In use, the apparatus 10 will be monitored for the presence of the magnetic field 12 with the globe 16 held static and, if the magnetic field 12 is not measurable, the globe 16 will be rotated to introduce the inertial forces into the molten metal 132. If the magnetic field 12 is still not measurable, charged particles or an electrical current may be introduced into the molten metal 132 inside the globe 16, as described below

With continued particular reference to FIGS. 2 and 3, globe 16 includes an annular spherical shell in the form of a mantle 146 that surrounds the outer core 120 and fills the volume defined between outer layer 104 and outer core 120. In one embodiment, mantle 146 is constructed from segments composed of a cast mixture of limestone and granite. It is contemplated, however, that mantle 146 may instead be made from other materials instead of, or in addition to, the limestone and granite of the representative embodiment. For example, mantle 146 may be made of a material including only one of limestone and granite. Alternatively, the mantle 146 may be composed of magma basalt silicates or another type of glass with a suitable composition to operate as a thermal insulator. Moreover, the mantle 146 of the representative embodiment is defined by twelve segments having complementary shapes such that, when coupled, may define the overall hollow-spherical shape of mantle 146. Those of ordinary skill in the art will readily appreciate that mantle 146, which functions as a thermal insulator, may be instead made of a single segment or a different number of segments.

Globe 16 includes features that permit the introduction of the molten metal 132 by a simple pouring process. In particular, a conduit 150 provides a fluid communication path between the outer surface 40 of globe 16 and the chamber 130 of outer core 120. More specifically, a first end 152 of conduit 150 is coupled with one of the shells 122 defining outer core 120 to thereby provide access to chamber 130. A second end 154 of conduit 150 is in the form of a funnel to facilitate pouring and directing of the molten metal 132 thereinto. Notably, conduit 150 may further facilitate the injection of energetic charged particles, such as electrons, into the chamber 130, which cooperates to further facilitate generation of magnetic field 12, although again Applicants do not wish to be bound by theory. Conduit 150 extends along the magnetic axis 14 that, in this illustrative embodiment, is oriented at an angle of about 11 degrees relative to the rotational axis 22.

Other features of globe 16 provide structural integrity thereto. For example, in this embodiment, a plurality of structural supporting hollow rods 166 extend from the inner core 110, through the outer core 120 and are coupled to the outer layer 104 of globe 16 to support the inner core 110 and outer core 120. Those of ordinary skill in the art will appreciate that other types of structural features may be present in addition or as an alternative to support rods 166. Notably, the hollowness of support rods 166 may permit injection of charged particles from device 80 into the chamber 130 containing the molten metal 132. Injection of charged particles into chamber 130 polarizes the domains of the molten metal 132 to thereby further facilitate the generation of magnetic field 12, although again Applicants do not wish to be bound by theory. The hollow tubes defined by support rods 166 may also permit the introduction of electric wires (not shown) that allow the introduction of an electric current into the inner core 110 and/or outer core 120 that would act as a seed current for the generated magnetic field 12. Moreover, the hollowness of support rods 166 may also permit the introduction of one or more thermocouples 168 therethrough (schematically shown as lines) that facilitate measurement of the temperature within chamber 130. The support rods 166 may be formed from a high temperature material, such as a nickel-based superalloy like Inconel®.

With continued particular reference to FIGS. 2 and 3, one or more electrical heaters 188 are operatively coupled to outer core 120. Heaters 188, such as silicon carbide rod-type heating elements, permit preheating the inside of the device and maintenance of a desired temperature of the molten metal 132 within chamber 130, for example, at a temperature of about 1300° C. In this regard, heaters 188 may be operatively coupled to a control system (not shown) that receives temperature data as positive feedback from the thermocouples 168 and selectively energizes heaters 188 in ways known in the art. Heaters 188 include terminal blocks in the form caps 189 that are accessible at the outer surface 40 of the globe 16 to permit coupling of wires 190 to the heaters 188 for transmitting electrical power to the heaters 188 from an external power source (not shown). In this illustrative embodiment, globe 16 has 24 heaters 188, more specifically two in each of the twelve segments defining the mantle 146. The tips of the heaters 188 are spaced by respective gaps from the outer surface of the inner core 110.

With reference to FIGS. 5 and 5A, in which like reference numerals refer to like features in FIGS. 1-4, an apparatus 10a includes a track 63a similar in most respects to track 63, but which is inclined or banked to permit rotation of the globe 16 with the axis 22 oriented at an angle, ε, relative to imaginary line 67.

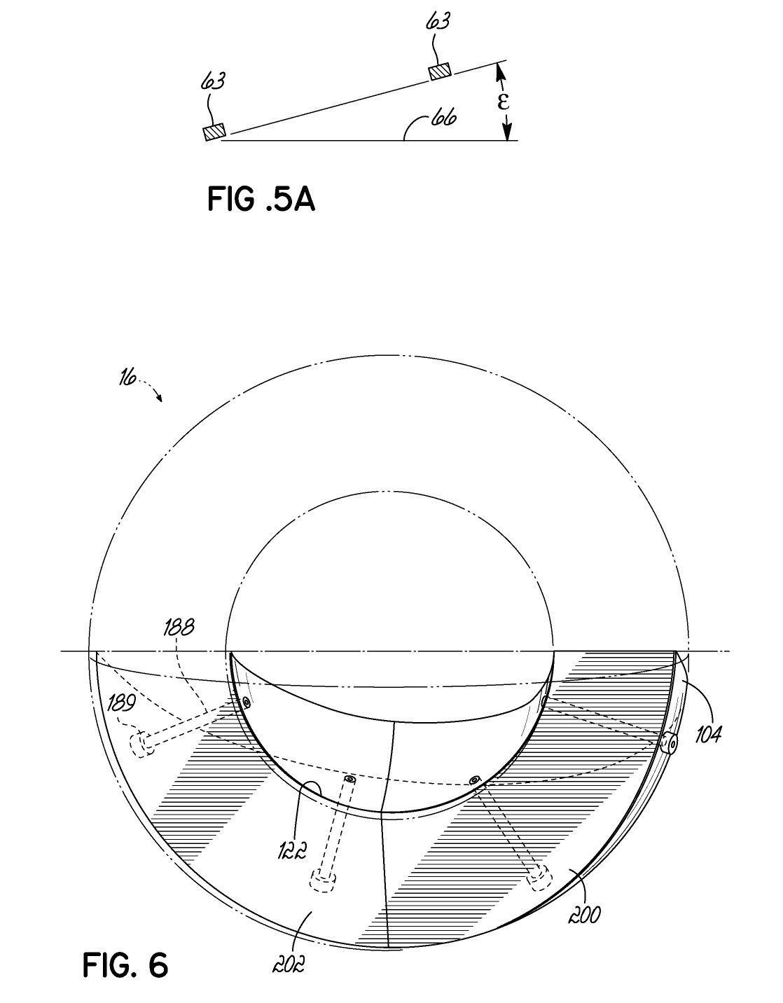

With reference to FIGS. 1-4 and 6, the apparatus 10 is assembled by initially mounting the lower hollow hemispherical shell 102 of the thin outer crust 104 to the support 18. The lower segments, such as the representative segments 200, 202, of the mantle 146 are placed inside the hemispherical shell 102, which holds the segments 200, 202 in place. The lower shell 122 is placed to rest on the segments 200, 202, as shown in FIG. 6. Amounts of a filler material (not shown) are applied to fill the seams between adjacent segments of the mantle 146, which functions to reduce heat loss through the seams. The segments 200, 202 of the mantle 146, as well as the other segments that are not visible in FIG. 6, support the mass of the outer core 120. The upper hemispherical opposed shell 122 of the outer core 120 is then joined to complete the spherical outer core 120. The support rods 166 penetrate through openings in the form of slots along the location where the opposed hemispherical shells 122 of the outer core 120 are joined. The upper segments of the mantle 146 are then placed into position. The heaters 188 extend into the annulus define between the upper and lower hemispheres of the mantle 146. The completed mantle 146 now rests inside the lower hemisphere 102 of the outer crust 104. The upper hemisphere 100 of the outer crust 104 is then lowered into position to complete the spherical outer crust 108. After the thermocouples 168 are inserted, the bolts are clamped to secure the globe 16.

While the invention has been illustrated by the description of one or more embodiments thereof, and while the embodiments have been described in considerable detail, they are not intended to restrict or in any way limit the scope of the appended claims to such detail. The various features described herein may be utilized alone or in any combination. Additional advantages and modifications will readily appear to those skilled in the art. The invention in its broader aspects is therefore not limited to the specific details, representative apparatus and method and illustrative examples shown and described. Accordingly, departures may be made from such details without departing from the scope or spirit of the general inventive concept.

What is claimed is:

1. An apparatus for generating a magnetic field, the apparatus comprising:
a spherical structure having a rotational axis;
a molten metal confined within said spherical structure, said molten metal composed of gray iron; and
a support coupled to said spherical structure, said support configured to rotate said spherical structure about said rotational axis,
wherein the rotation of said spherical structure is capable of inducing Coriolis inertia forces in said molten metal to generate the magnetic field.

2. The apparatus of claim 1, further comprising:
one or more magnetometers positioned proximate to an outer surface of said spherical structure, said one or more magnetometers configured for measuring the magnetic field.

3. The apparatus of claim 1, further comprising:
a first drive mechanism operatively coupled to said spherical structure, said first drive mechanism configured to effect the rotation of said spherical structure about said rotational axis.

4. The apparatus of claim 1, further comprising:
a main drive mechanism operatively coupled to said support, said main drive mechanism configured to revolve said spherical structure about an orbital motion axis spaced from said rotation axis of said spherical structure.

5. The apparatus of claim 4, wherein the rotation of said spherical structure about said orbital motion axis defines a plane of orbital motion, and said rotational axis is oriented at a tilt angle relative to an imaginary line perpendicular to said plane.

6. The apparatus of claim 1, wherein said support is coupled to two diametrically opposed points on said spherical structure, and said support includes at least one thrust bearing at one of said two diametrically opposed points for supporting said spherical structure.

7. The apparatus of claim 1, wherein the spherical structure includes a solid inner core and an outer core containing the molten metal, and further comprising:
a device configured to selectively inject a plurality of charged particles or a small electric current into the molten metal contained by the outer core or into the solid inner core.

8. The apparatus of claim 1, wherein said spherical structure includes an inner core and an outer core disposed about said inner core, said inner core formed from a first material having a melting point greater than a melting point of a second material forming the outer core so that said inner core remains solid at a temperature between the melting points of the first and second materials.

9. The apparatus of claim 1, wherein said spherical structure includes an inner core and an outer core disposed about said inner core, said outer core having a chamber configured to contain the molten metal.

10. The apparatus of claim 9, wherein said spherical structure includes a plurality of heaters operatively coupled to said chamber, said heaters configured to heat the molten metal within said chamber.

11. The apparatus of claim 1, wherein said spherical structure includes a chamber containing the molten metal and a mantle disposed about said chamber, said mantle composed of a thermal insulator.

12. The apparatus of claim 1, wherein said spherical structure includes an outermost spherical layer composed of a polycarbonate.

13. An apparatus for generating a magnetic field, the apparatus comprising:
a spherical structure having a rotational axis, a spherical solid inner core, and a spherical shell arranged concentrically with the inner core to define an outer core;
a molten metal confined within a chamber between said outer core and said inner core; and
a support coupled to said spherical structure, said support configured to rotate said spherical structure about said rotational axis,
wherein the rotation of said spherical structure is capable of inducing Coriolis inertia forces in said molten metal to generate the magnetic field.

14. The apparatus of claim 13, wherein said molten metal is composed of gray iron.

15. The apparatus of claim 13, further comprising:
one or more magnetometers positioned proximate to an outer surface of said spherical structure, said one or more magnetometers configured for measuring the magnetic field.

16. The apparatus of claim 13, further comprising:
a device configured to selectively inject a plurality of charged particles or a small electric current into the molten metal contained by the outer core or into the solid inner core.

17. The apparatus of claim 13, further comprising:
a mantle disposed about said outer core, said mantle composed of a thermal insulator.

18. A method of generating a magnetic field with a spherical structure having a diametrical rotational axis, the method comprising:
partially filling a spherical structure with molten gray iron; and
rotating the spherical structure about a rotational axis thereof to thereby induce inertial and Coriolis forces in the molten gray iron capable of generating the magnetic field.

19. The method of claim 18, further comprising:
revolving the spherical structure about an orbital motion axis spaced from the diametrical rotational axis of the spherical structure.

20. The method of claim 18, further comprising:
injecting energetic charged particles into the molten metal.
